(19) United States
(12) Patent Application Publication
(10) Pub. No.: US 2005/0249388 A1
(43) Pub. Date: Nov. 10, 2005

(54) Three-dimensional fingerprint identification system

(76) Inventor: Miguel A. Linares, Bloomfield Hills, MI (US)

Correspondence Address: GIFFORD, KRASS, GROH, SPRINKLE & CITKOWSKI, P.C, PO BOX 7021, TROY, MI, 48007-7021, US

(21) Appl. No.: 10/841,349

(22) Filed: May 7, 2004

(51) Int. Cl. G06K 9/00

(52) U.S. Cl. 382/124; 382/154

(57) ABSTRACT

A three-dimensional fingerprint based personal identification system for creating a three-dimensional map of a finger of an individual, such as which is placed in contact with a transparent surface, and linked to other personal details associated with the individual. The fingerprint identification system includes fingerprint image acquisition hardware, pattern storage and matching software, as well as a database storage and retrieval system for accessing a fingerprint and associated information for subsequent display.

### BACKGROUND OF THE INVENTION

1. Field of the Invention

The present invention generally relates to fingerprint verification systems and methods and, more particularly, to a system and method for accessing and obtaining three-dimensional information relative to human fingerprints.

2. Discussion of the Prior Art

The prior art is well documented with various examples of fingerprint accessing and identification units. A common occurrence in the prior art is the provision of varying types of two-dimensional, or flat, scanning devices for accessing identification information relevant to a human finger or thumb print.

The U.S. patent to Takhar et al. (U.S. Pat. No. 6,002,787), directed to a Fingerprint Analyzing and Encoding System, teaches of a system for converting an image-enhanced digitized raster fingerprint image to vector lines in order to generate an identification value for the fingerprint. The raster image pixels are converted to vector lines along the fingerprint ridges and the vector lines are classified and converted according to type. The line types are then analyzed and a list of identification features corresponding to the vector line types is generated. The identification features between vector line types are compared and the image is classified according to fingerprint class. An identification value is then generated by numerically encoding the classified identification features. All of the classification means is based upon two-dimensional information.

U.S. patent to Scott et al. (U.S. Pat. No. 6,111,977) of a Hand-held Fingerprint Recognition and Transmission Device stresses portability in design. A portable fingerprint recognition transmitter operates to take an image of a fingerprint and transmits the fingerprint image via infrared or radio frequency to a receiver having previously stored fingerprint images for comparison. The system is described as a closed circuit system using stored images for the purposes of unlocking a security area. This device employs two-dimensional scanning to produce the image used for comparison.

Ross (U.S. Pat. No. 6,195,447) discloses a System and Method for Fingerprint Data Verification. The disclosure teaches of a system and method for authenticating fingerprints remotely with a scanner for generating fingerprint data. A local site connects to the remote site via transmission cables and includes a processor for extracting minutia for the fingerprint data. A comparator matches the fingerprint data to historical fingerprint data maintained in a database to verify whether the detected fingerprint data falls within statistical maximum deviations to establish the authenticity of the fingerprint.

The U.S. patent to Gagne et al. (U.S. Pat. No. 6,212,290) is directed toward a Non-Minutiae Automatic Fingerprint Identification System and Methods and teaches of a system for verifying a person's identity. The image of a fingerprint of a person to be identified is provided on a lens means, which when touched by a finger of the person causes immediate development of an image of the fingerprint of the finger in a black and white appearance. This image of the fingerprint is video scanned to produce image data, which is digitized to produce a non-minutiae numerical identifier indicative of the fingerprint. The non-minutiae digitized numerical identifier is provided by selectively analyzing different parts of a fingerprint and deriving from each part a byte numeric which is directly related to ridge count for that particular section. The scanning in this example is again two-dimensional.

None of the above referenced patents either teaches or suggests a means for scanning three-dimensional fingerprint data, which can process the design of the fingerprint including, but not limited to, the distance between each line, and also the depth surface of lines of each fingerprint.

It is therefore an object of the invention to provide a system and method for obtaining three-dimensional data of a fingerprint.

It is another object of the invention to provide a system and method for obtaining three-dimensional fingerprint data consisting of the distance between each line, and also the depth surface of lines of each fingerprint.

It is also an object of the invention to provide a system and method for obtaining three-dimensional data of a fingerprint that employs laser scanning technology to scan a three-dimensional image of a finger.

It is a further object of the invention to provide system and method for obtaining three-dimensional data of a fingerprint employing pattern storage and matching software to file and/or match scanned three-dimensional fingerprint images with a pre-stored fingerprint pattern for personal identification.

It is an additional object of the invention to provide a system and method for obtaining three-dimensional data of a fingerprint that employs personal database storage and retrieval of a scanned three-dimensional fingerprint image and other personal data.

It is a still further object of the invention to provide a system and method for obtaining three-dimensional data of a fingerprint employing image processing means for digitizing and translating the fingerprint images.

### SUMMARY OF THE INVENTION

The present invention features a three-dimensional fingerprint based personal identification system. This system is designed to provide a unique three-dimensional map of the finger of an individual, which is placed in contact with a transparent surface, and link it to his/her other personal details. This three-dimensional fingerprint identification system consists of three major components for operation. The first component comprises the fingerprint image acquisition hardware. The second component comprises the pattern storage and matching software. The third component of the present invention comprises the database storage and retrieval system.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a diagrammatic view of the components of the three-dimensional fingerprint identification system according to the present invention;

FIG. 2 is a flowchart illustrating the operation of the three-dimensional fingerprint identification system illustrated in FIG. 1;

FIG. 3 is a sectional plan view of the Fingerprint Image Acquisition Hardware in accordance with the present invention;

FIG. 4 is an illustration of a plurality of conventional fingerprint patterns as known in the relevant art and with which the three-dimensional system and method of the present invention is employed;

FIG. 5 is plan view of an exemplary scanned fingerprint utilizing the three-dimensional scanning system according to the present invention; and

FIG. 5A is a cross section of the exemplary scanned fingerprint of FIG. 5.

### DESCRIPTION OF THE PREFERRED EMBODIMENT

The present invention relates to a system for obtaining a laser-scanned digitized fingerprint image in order to generate a database of stored fingerprints for subsequent identification of an individual. The system performs stereoscopic scanning of a finger to develop a unique three-dimensional map of the finger of an individual, and which can thereby be linked to his/her personal details. It will be recognized that the present invention may be used in numerous other applications without loss of generality. The present invention is described hereinbelow in the application regarding security and personal identification utilities.

The basic fundamentals in the science of fingerprint identification are permanence and individuality. Fingerprints ridges are formed during the third to fourth month of fetal development. These ridges consist of individual characteristics called ridge endings, bifurcations, dots and many ridge shape variances. The unit relationship of individual characteristics does not naturally change throughout life. Unnatural changes to fingerprint ridges include deep cuts or injuries penetrating all layers of the epidermis and some diseases such as leprosy.

In the over 140 years that fingerprints have been routinely compared worldwide, no two fingerprints on any two persons (including twins) have been found to contain the same individual characteristics in the same unit relationship. This means that in general, even with an area the measure of a few millimeters wide, the fingerprints of one person will contain sufficient individual characteristics in a unique unit relationship to enable positive identification to the absolute exclusion of any other person on earth.

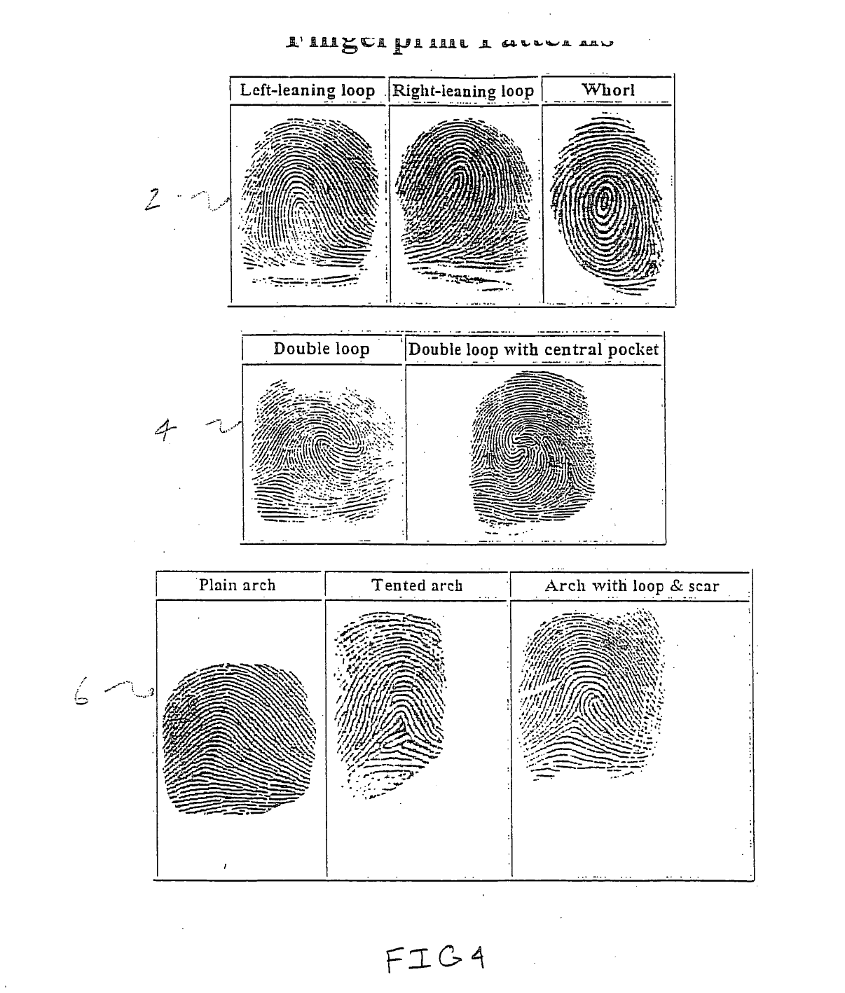

Fingerprint patterns comprise class characteristics such as loop, arch formations, whirl ridge patterns, ridge counts and tracings between different pattern focal points (deltas and cores) for the purposes of identification. Individual sets of fingerprint patterns are illustrated at 2, 4 and 6 in FIG. 4. The present invention is further based on dactyloscopy, i.e., the practice of using fingerprints to identify individuals.

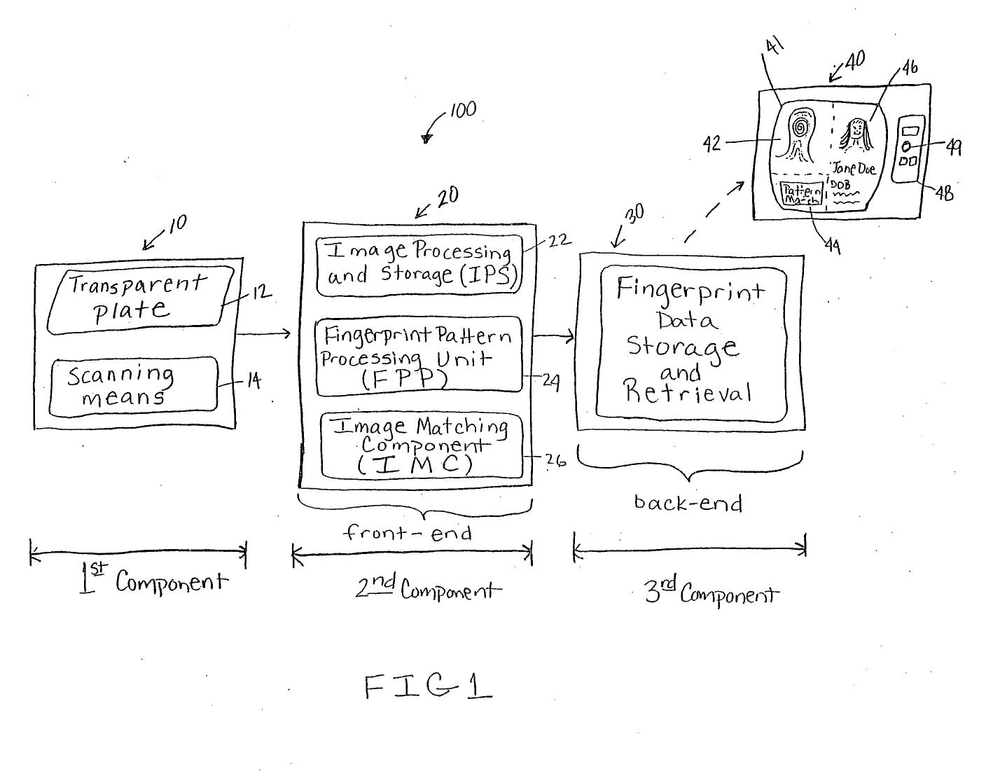

In operation, the three-dimensional fingerprint identification system 100, in accordance with the present invention, consists of three major components for operation, as illustrated diagrammatically in FIG. 1. A first component is illustrated as a fingerprint image acquisition hardware unit (FIAH) 10 which consists of a transparent plate 12 and a scanning unit 14.

A second component consists of a fingerprint processing software 20, broken down into an image processing and storage (IPS) unit 22, a fingerprint pattern processing unit (FPP) 24 and an Image Matching Component (IMC) 26. A third component of the present invention comprises a database management sub-system 30.

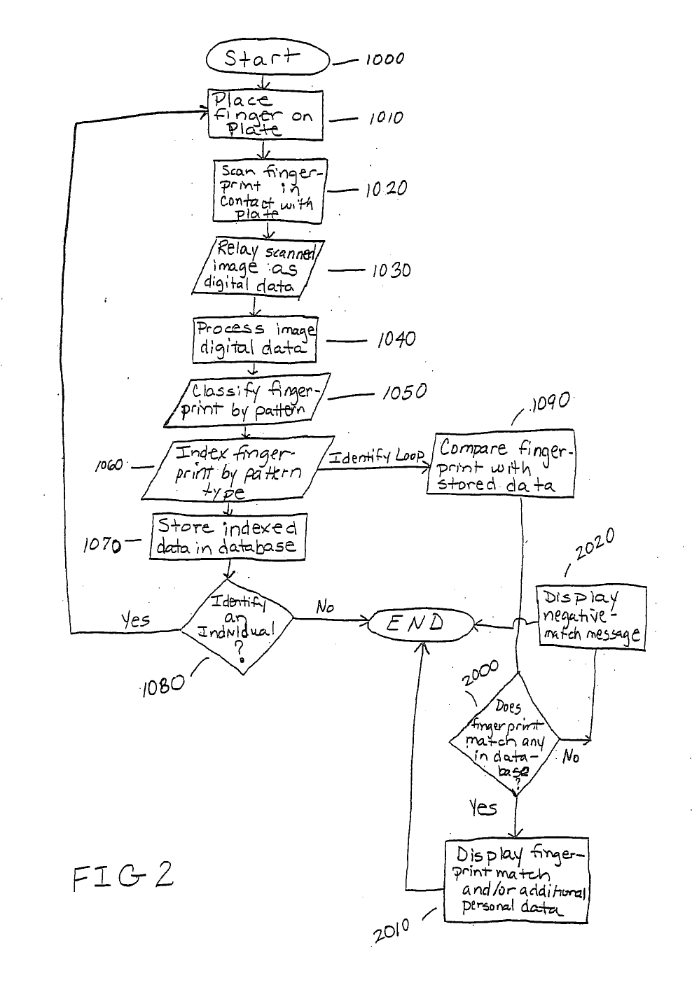

Referring now to FIG. 2, a flowchart showing the operation of the fingerprint identification system 100 is presented by which steps 1010 through 1030 illustrate operations of the fingerprint image 10 acquisition hardware unit 10. The steps associated with the operation of the FIAH 10 include placing the finger on the plate 1010, scanning the fingerprint in contact with the plate 1020, and relaying the scanned image as digital data 1030.

Additional steps 1040-1060 and 1090-2000 indicate operation steps performed by the fingerprint processing software 20. These steps associated with the operation of the fingerprint processing software 20 include processing the image digital data 1040; classifying the fingerprint pattern 1050; and indexing the fingerprint by pattern type 1060. At step 1070, the indexed data is stored in a database, representative of the operation performed via the database management sub-system 30.

Once an individual approaches the system for identification, as shown at step 1080, the fingerprint is compared with fingerprint data stored in the database 1090 to determine if a match exists therein 2000. This manipulation is done by the fingerprint software system 20. If a match is found within the database then the fingerprint match and/or the additional information about the individual is displayed at 2010 via a display unit 40 in operative communication with the data storage and retrieval unit 30, see again FIG. 1. Alternately, and if no match is found in the database 30, a message indicating such is displayed at step 2020 by the display 40. Each of the components will be described in further detail hereinbelow.

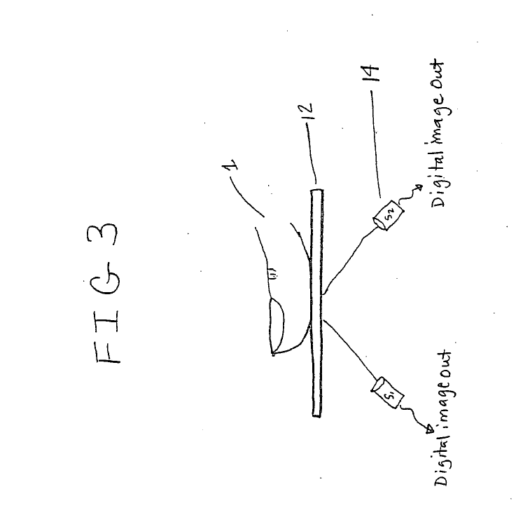

In a preferred embodiment, and referencing also FIG. 3, the FIAH hardware unit 10 employs stereoscopic laser imaging to acquire a three-dimensional fingerprint image. The hardware used again consists of the laser scanner 14 deployed beneath the clear, flat plate 12 (FIG. 3). The clear plate 12 can be any suitable transparent glass plate such as those commonly used in the well known flatbed or desktop scanners. A finger or the thumb 1 is placed in direct contact with the plate 12 for fingerprint image capture.

Beneath the plate is located the laser scanner unit 14 and which as again illustrated in FIG. 3, consists of two independent laser beams from two laser sources S1 and S2 which operate to scan the patterns of the fingerprints. Each laser is programmed to scan predetermined cross sections of the finger 1 and thus obtain two independent digital images of the same finger. These two images when superimposed would be able to generate a stereoscopic three-dimensional image of the finger 1 that would not only contain the information about the physical location of the fingerprint patterns but also the information about the depth of each furrow of the finger 1. The stereoscopic image is then processed by the fingerprint processing software 20, and then subsequently stored in the database 30 along with other relevant information about the individual (e.g., photograph, data entered information, etc.), depending upon the desired application.

The fingerprint processing software 20 may be specific front-end software based on available client-server technology. This software is bound to the FIAH 10 and may employ specific drivers for acquiring images from the FIAH 10. The software may be Windows™ based and may employ specific drivers for acquiring images from the scanning software. The software preferably consists of three specific components again including the Image Processing and Storage component (EPS) 22, the Fingerprint Pattern Processing unit (FPP) 24, and the Image Matching Component (IMC) 26.

The EPS 22 comprises an image processor that interfaces with the FIAH 10 hardware component and acquires the stereoscopic image of the fingerprint. The IPS 22 gathers the digital image data provided by the laser scanning and translates the acquired images into bitmaps. The bitmaps will then make use of the digitized information by translating it into an image-representation consisting of rows and columns of dots. The bitmaps are then compressed for efficient storage and use via the IPS 22. These bitmaps of the fingerprint patterns may further be translated into pixels for visual output on a display means 40 along with other accompanying information about the individual.

The display unit 40, in a preferred variant, includes a video monitor, a television screen, a closed circuit TV (CCTV), or the like. The display unit 40, see again FIG. 1, typically includes a multi-segmented display screen 41 for displaying, for example, the fingerprint image 42, an accompanying picture of the individual including text of a personal data 46, and textual messaging 44. A control panel 48 may include input keys 49 in association with the display unit 40 for scrolling through further information.

The fingerprint processing software 20 further includes the Fingerprint Pattern Processing unit (FPP) 24 that performs the functions of analyzing, classifying, and indexing the fingerprint patterns.

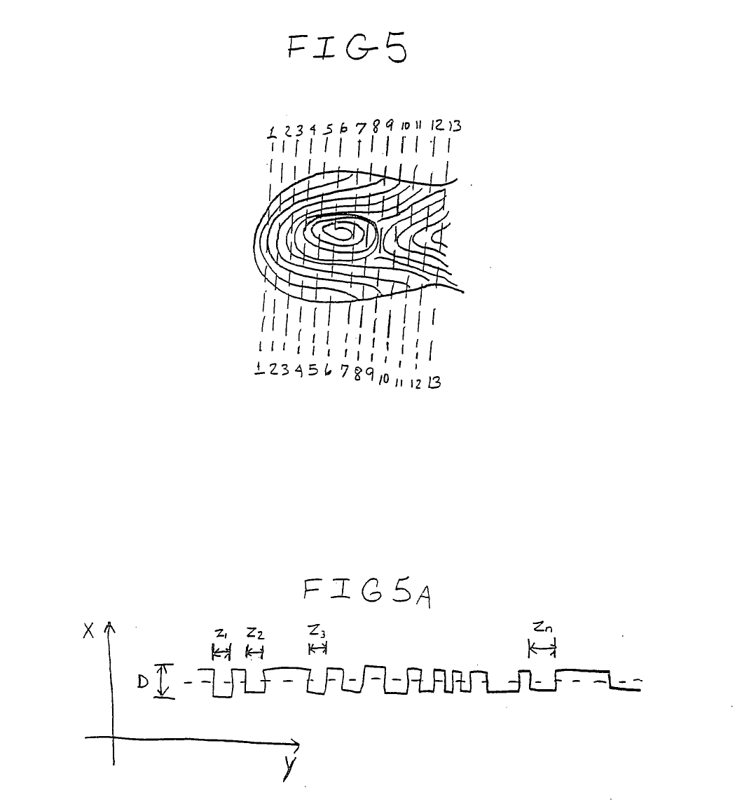

FIG. 5 illustrates a plurality of scan lines associated with the stereographic image created by the laser scanner unit 14. Each laser source S1 and S2 scans across the finger 1 in contact with plate 12 along scan lines 1-1, 2-2, 3-3, and so on.

FIG. 5A illustrates a pictorial translation of scanned image data of each of the scan lines, and providing information regarding the depth of the furrows of a fingerprint D, upon an x-axis; as well as a distance between the furrows Z1, Z2, etc., on a y-axis. It is this translated fingerprint pattern image data that is processed by the FPP 24 into usable data.

The Image Matching Component, (IMC) 26 is configured to interface with the database management sub-system 30 for matching the fingerprint images with previously stored images. These components are then matched with the image components stored in the back-end database management sub-system 30 utilizing efficient searching and sorting algorithms. Once a match is found, the component provides accompanying information stored in the back-end database management sub-system 30 regarding the particular individual so identified and display on the visual output display 40. The information can be “layered” so that only minimum relevant information is displayed by default and further information is displayed upon prompting by a user with the user interfacing with control panel 48 of display unit 40, or alternatively via other input means (not shown).

The fingerprint pattern is then dispatched for storage on the back-end database management system 30 (described in detail below). In addition to the stereoscopic image, the IPS 22 component is designed to accept further information about the individual from input devices such as, but not limited to, a keyboard or a simple graphic scanner (not shown). The entire information acquired may be sent to the back-end database engine for storage in a normalized database. The system 100 may be back-end independent and able to interface with standard database engines like ORACLE™, Sybase™, AcceSS™, SQL-Server™, etc.

As for the database management sub-system 30, it will employ a standard and tested back-end database management scheme to store and retrieve the individual information. The relevant information to be managed by the database management sub-system 30 includes the stereoscopic fingerprint image, the digitized identifiable components of the three-dimensional image; and relevant information about the individual. It is also envisioned however that the front-end software will be independent of the back-end engine employed as in any typical client/server application.

Since other modifications and changes varied to fit a particular operating requirements and environment will be apparent to those skilled in the art, the invention is not considered limited to the example chosen for purposes of disclosure, and covers all changes and modifications which do not constitute a departure from the true spirit and scope of the invention.

For example, the FIAH 10 may comprise video scanning in lieu of laser scanning technology. In the instance of video scanning, a further image processing step of converting the image from analog to digital form may be performed. Analog cameras (non-digital) may be used to capture the image of the cards. These may include video recording cameras. Herein, an analog-to-digital converter may be used to simplify the image data for display output. Any suitable camera or camera-type device known in the art may be used to capture the image of the fingerprint.

Alternatively, a digital camera (not shown) may be used to acquire the image of the fingerprint. It is well known to those in the art that digital cameras utilize CMOS (complementary metal-oxide semiconductor) technology. Herein, CMOS chips have an advantage of using low power requirements. In addition, the CMOS sensor can be loaded with a host of other tasks that can be translated to the operation of the IPS 22 component, such as analog-to-digital converting, load signal processing, handling white balance and more camera controls. For example, CMOS chips are high resolution sensors with space efficiency capability enabling sensor designs with the possibility of increasing density and bit depth without significant cost increases.

A digital video camera (DV camera), not shown, may also be employed to capture digital video images, thereby reducing steps of video microprocessing. The output of a DV camera is already in compressed, digital format. Therefore, all that is needed is to transfer the acquired fingerprint images straight from the camera for post capture processing.

Any suitable means for capturing image data known in the art, such as, but not limited to, lenses, mirrors, fiber optics, fiber optical transmission tubes, optical sensor arrays, photosensitive diodes and/or any combinations thereof may be used to capture the photonic information and relayed to any choice of camera means to thereby obtain an image of the finger in contact with the plate.

A method for obtaining and processing a three-dimensional fingerprint image is also disclosed and includes the steps of capturing a stereoscopic fingerprint image, processing the fingerprint image as a digital data input, storing the data input in a data storage and retrieval subsystem, and retrieving the digital data for visual illustration upon a display unit. Additional steps include scanning at least two laser sources for capturing said stereoscopic fingerprint image, each laser scanning sections of a finger, in a sweeping manner, producing sections with overlapping scan lines. A yet further step includes mapping the image data for bitmap formatting, digitally compressing the image data, and storing the compressed data for subsequent display.

Having described my invention, other and additional preferred embodiments will become apparent to those skilled in the art to which it pertains, and without deviating from the scope of the appended claims.

1. A three-dimensional fingerprint identification system comprising:
a fingerprint acquisition unit for capturing a stereoscopic fingerprint image;
a fingerprint processing unit, operatively connected to said fingerprint acquisition unit, for processing said captured fingerprint image as digital data; and
a database management sub-system for storage and retrieval of said digital data.

2. The three-dimensional fingerprint identification system as described in claim 1, further comprising:
said fingerprint image acquisition unit comprises a transparent plate and at least one laser scanner for obtaining a fingerprint image by optically scanning a finger placed in contact with said plate; and
said transparent plate and said laser scanner are in optical communication such that said digital data is directly relayed, via said laser scanner, to said fingerprint processing unit.

3. The three-dimensional fingerprint identification system as described in claim 2, said laser scanner further comprising at least two laser sources positioned such that each scans sections of the finger placed in contact with said transparent plate in a sweeping manner producing sections with overlapping scan lines, said overlapping sections providing stereoscopic images.

4. The three-dimensional fingerprint identification system as described in claim 3, said fingerprint processing unit further comprising an image processor and a fingerprint processing software configured to interface with said image processor to analyze, classify and index said captured fingerprint image.

5. The three-dimensional fingerprint identification system as described in claim 4, further comprising a client-server configuration with said fingerprint processing software defining a front-end application and said database management sub-system defining a back-end application.

6. The three-dimensional fingerprint identification system as described in claim 1 further comprising said image processor being configured to map an image data for bitmap formatting, compress said image data, and store said image data.

7. The three-dimensional fingerprint identification system as described in claim 6 further comprising a visual output for displaying information of an individual, and wherein said image processor is further configured to convert said bitmap images into pixels for display of said bitmap images as fingerprints on said visual output in conjunction with said displayed individual information.

8. The three-dimensional fingerprint identification system as described in claim 7, said visual output further comprising a visual output display including at least a monitor, a television screen, and a closed circuit TV.

9. The three-dimensional fingerprint identification system as described in claim 2, said fingerprint image acquisition unit further comprising a video scanning unit.

10. The three-dimensional fingerprint identification system as described in claim 9, said fingerprint processing unit further comprises an image processor and fingerprint processing software configured to interface with said image processor to analyze, classify and index said captured fingerprint image.

11. The three-dimensional fingerprint identification system, as described in claim 10, further comprising said image processor being configured to map said image data for bitmap formatting, compress said digitized image data, and store said image data.

12. The three-dimensional fingerprint identification system as described in claim 10, said fingerprint processing unit further comprising an image processor having an analog-to-digital converter.

13. A method for obtaining and processing a three-dimensional fingerprint image, said method comprising the steps of:
capturing a stereoscopic fingerprint image;
processing said fingerprint image as a digital data input;
storing said data input in a data storage and retrieval subsystem; and
retrieving said digital data for visual illustration upon a display unit.

14. The method as described in 13, further comprising the step scanning at least two laser sources for capturing said stereoscopic fingerprint image.

15. The method as described in claim 14, further comprising the step of each laser scanning sections of a finger, in a sweeping manner, producing sections with overlapping scan lines.

16. The method as described in claim 15, further comprising the steps of:
mapping said image data for bitmap formatting;
digitally compressing said image data; and
storing said compressed data for subsequent display.
